(19) United States
(12) Patent Application Publication
(10) Pub. No.: US 2010/0057980 A1
(43) Pub. Date: Mar. 4, 2010

(54) DATA MEMORY DEVICE WITH AUXILIARY FUNCTION

(76) Inventors: Hans Aschauer, Munchen (DE); Armin Bartsch, Grobenzell (DE)

Correspondence Address: BACON & THOMAS, PLLC, 625 SLATERS LANE, FOURTH FLOOR, ALEXANDRIA, VA, 22314-1176, US

(21) Appl. No.: 12/515,205

(22) PCT Filed: Nov. 13, 2007
(86) PCT No.: PCT/EP07/09811

§ 371 Date: May 15, 2009

(30) Foreign Application Priority Data
Nov. 16, 2006 (DE) 10 2006 054 025.5

(51) Int. Cl. G06F 12/00; G06F 12/02

(52) U.S. Cl. 711/103; 711/154; 707/824; 711/E12.001; 711/E12.008; 707/E17.01

(57) ABSTRACT

The invention relates to a method, a data storage device, and a system with a data storage device having an additional module (18,28), wherein the data storage device comprises at least one memory area, which can be accessed via specific memory structures or addresses, and at least one controller (16, 26) for controlling the access to the memory module, wherein at least one of the specific memory structures or addresses is defined as an additional functional address, and wherein the controller (16, 26) forwards an access to the memory module, which is effected via the additional functional address, to the additional module (18, 28).

The invention relates to mass storage media having an additional function. In particular, the invention relates to memory cards with a security function.

Portable mass storage devices with ever increasing storage capacity are used in a multitude of electronic devices. Digital contents or text, picture, audio or video data or the like can be stored thereon. In this context portable mass storage devices have the advantage that they can be read and, if applicable, written to by various electronic devices such as PCs, PDAs, smart phones, digital cameras, audio devices, etc. In this way, the portable mass storage devices permit a simple back up and transport of digital contents. But using them requires that each of the electronic devices is provided with a suitable read/write device integrated in a hardware platform and an appropriate driver for accessing the mass storage devices.

Various standards have been developed for this purpose whose degree of acceptance varies. Widely used mass storage devices are, for example, multimedia cards (MMC), secure digital memory cards (SD cards), micro SD cards, memory sticks (USB sticks), but also CDs, DVDs etc. In order for the mass storage devices to function in a multitude of devices, drivers have to be provided for the respective operating systems of the hardware platforms.

In many cases it is desirable to additionally provide the mass storage devices with security functions or also other further functions, so as to protect, for example, certain digital contents of the memory from unauthorized access. Such a security functionality can be achieved by smart card chips, as known from chip cards, by integrating the smart card chip in the mass storage card.

DE 698 15 258 discloses programmable, erasable and nonvolatile memories which have a read and/or write-protectable zone, wherein an absolutely defined memory-independent boundary address, a protection register, divides the write-protectable zone from the other memory areas and it can be chosen on which side of the boundary address the write-protectable zone is to be located. For this purpose a protection word can be written in the protection register to define location and size of the write-protectable zone.

EP 1 304 702 discloses a portable semiconductor memory card and a data reading device for the memory card in an electronic apparatus, with which digital contents can be protected. The memory card comprises a re-writable, nonvolatile memory with an authentication area and an area not to be authenticated. The memory card additionally comprises a control circuit having a control unit for the area not to be authenticated and an authentication unit which runs an authentication process to check whether the electronic apparatus is authorized to access the authentication area via an access control system for the authentication area. The electronic apparatus here communicates in encrypted form, and after the decryption of the commands the access control system decides whether the protected area is accessed.

The known systems have the disadvantage that the data to be protected are stored only in a certain and limited portion of the memory and special drivers are required to access the memory card. Setting up special drivers is elaborate and impractical, since in case of different devices with different operating systems, special drivers have to be developed and implemented for each. Moreover, not all systems allow the user to subsequently set up special drivers, e.g. in smart phones which are operated with the operating system “Symbian”.

Therefore, it is the object of the invention to provide a memory device with a security function in such a way that for accessing the security function of the memory device the use of special drivers is not required. It is a further object of the invention to provide a controller for such a memory device, a method, and a system for operating a memory device in such a way that for accessing the security function of the memory device the use of special drivers is not required. Furthermore, it shall be possible to activate an additional function through standardized commands.

For achieving the object the invention proposes a method, a data storage device, and a system with a data storage device having an additional module, wherein the data storage device comprises at least one memory area which can be accessed via specific memory structures or addresses, and which comprises at least one controller for controlling the access to the memory module, wherein at least one of the specific memory structures or addresses is reserved or defined as an additional functional address, and wherein the controller converts an access to the memory module, which is effected via the additional functional address, into instructions to the additional module and forwards these.

The data storage device according to the invention can be used in a system, which additionally comprises a terminal, wherein the terminal accesses the data storage device via a standard interface.

Terminals can be electronic devices or terminal devices of any kind, which are provided with an interface for data storage devices, such as for example personal computers (PC), PDAs, smart phones, digital cameras, digital audio systems or the like.

The terminal device or the electronic apparatus can be operated with a standard operating system for terminal devices, such as for example PocketPC, Symbian, Windows, or Linux, but can also be a JAVA platform.

A software, application, or application program accesses the mass storage card via suitable drivers of the operating systems, wherein an insuction set is determined via the driver, with which a communication between the application or the terminal device and the mass storage card or the data storage device according to the invention can be effected, in particular an access to the data storage device can be effected.

The standard interface can be provided in a receiving means for the data storage device. The receiving means can be designed for inserting and for accessing one or more types of mass storage cards. In particular, the receiving means can be a read and/or write device for mass storage cards. In a preferred embodiment the standard interface is an MMC or SD interface, as is used for commercially available mass storage cards.

The data storage device according to the invention can have the form and functionality of a commercially available portable mass storage medium, such as a multimedia card (MMC), an SD memory card, a micro SD, a compact flash card, or a memory stick, or USB stick or other electronic devices which are provided or can be provided with a controller (e.g. mobile data carriers such as CDs, DVDs etc) and are used compatibly therewith. Advantageously, thus, all terminal devices already commercially available can be used further. Terminal devices used thus far can access the data storage device according to the invention in the same way as the commonly known data storage devices, which means a clear cost advantage. This is possible, because both the data storage device used thus far and the data storage device according to the invention can use the same interfaces, the same drivers, the same host controllers, and the same commands.

The memory module can be a nonvolatile memory, for example a commercially available flash memory, as is used in mass storage cards. Other types of memory modules, too, lie within the scope of this invention, such as RAM or ROM memory modules or miniaturized hard disks.

Accessing the memory module is effected via an address. The address directly or indirectly indicates, i.e. via references, indicators or pointers, at which point in the memory an access is to be effected. The address can be one of several parameters, with which the access is effected, e.g. besides the kind of access command: such as READ; WRITE; SEARCH etc, data, authentication data etc. The allocated address directly or indirectly indicates, where the memory module is to be accessed, in particular which memory block or which memory blocks.

In a preferred embodiment an address corresponds to a special memory structure in the memory module, i.e. to one or more block-addresses, which according to the invention are reserved for the additional functionality. In an alternative embodiment the special memory structure is formed by at least one file in the file system, the thus reserved file—e.g. via an entry in the directory and/or a file allocation table—is allocated to a permanent block address.

In a preferred embodiment accessing the memory module is effected via commands, the commands applying to all addresses, i.e. to both “normal” memory addresses and to reserved memory addresses for executing the additional function. The commands here are standardized and independent of the allocated address. The commands are based on the operating system used and/or the driver for the mass storage card. The commands comprise commands common for mass storage cards such as read and/or write commands, but also search commands, identification commands etc.

Thus, the commands are determined by the application, the operating system, and/or by the driver of the terminal device. Advantageously, it is not necessary to use special drivers or special commands for the data storage device according to the invention to operate security functions on the card, but standard commands and standard drivers for commercially available mass storage cards can be used. This advantageously permits the data carrier device with additional module according to the invention to be operated with terminal devices which are provided with drivers and operating systems for commercially available mass storage cards. Thus, a special driver or a special operating system for the additional module is not required.

According to the invention the controller controls the access to the cards, in particular to the memory module, in that from the quantity of addresses specific addresses are chosen and reserved as additional functional addresses for accessing the additional module, so that one or more additional functional addresses are defined in the controller and the controller, by evaluating the address via which the memory module is accessed, can execute predetermined functions when an access is effected via the additional functional address.

The controller evaluates all accesses to the card and captures the address of each access. It is checked whether or not the address is the predefined additional functional address. In the affirmative, the controller redirects the access to the additional module and activates the additional functionality or executes it. Otherwise, the usual access to the data storage device and/or the memory module can be effected.

In a preferred embodiment it is provided to simply forward the access in an unmodified manner to the additional module, without modifying the access itself. But the function of the controller according to the invention may also consist in executing a certain procedure and forwarding the access in a modified form, for example through instructions generated by the controller, to the additional module. The procedure to be executed can depend on the kind of access, in particular on the command itself or its parameters, so that with the help of different commands or/and parameters a multitude of procedures can be executed via one single additional functional address. In this way, accesses specific for an additional module can be effected, without the driver of the terminal device having to be configured for this, when the controller adapts or converts commands conforming to standard drivers into instructions specific for the additional module.

In a preferred embodiment the controller evaluates accesses addressed to the memory module, and when accesses are effected via the additional functional address, it activates the additional module. In this embodiment the additional module can become active itself and execute various processes, for example, on the basis of the command and/or its parameter or on the basis of the modified access received from the controller.

In a further embodiment the additional module comprises an additional controller. With such an additional controller the accesses forwarded by the controller can be further processed and functions and processes specific for an additional module can be activated or executed.

In a preferred embodiment the additional module is a security module, in which an access via the additional functional address activates a security functionality of the security module. The activatable security functionality here can comprise the backup and/or protection of certain data in the data storage device. By means of the security module, however, there can also be executed, triggered and/or controlled other security-relevant processes.

In a further special embodiment the additional module or the security module comprises a smart card chip. This can be a commercially available smart card chip or a chip especially designed or adapted for being applied according to the invention. The functions of the smart card chip are activated by the controller evaluating the accesses to the storage device, optionally converting them, and forwarding them to the smart card chip.

In an alternative embodiment the additional module comprises a reserved memory area of the memory module. A separate module is not provided here, but the additional module is integrated in the memory module or forms a part of the memory module. For example, a certain memory area or a partition of the memory can be used as an additional module. When such an area is used as a security module, the separate and thus secure memory area can be accessed e.g. only in the case of an access via the additional functional address.

In a special embodiment the addresses, via which the memory module is accessed, are block addresses of the memory module. A command or access to the memory module has allocated thereto a direct block address indicating which memory block is to be accessed, in particular, from which memory block is to be read or in which memory block is to be written. In this embodiment the address allocated to the access directly indicates where the memory is to be accessed.

In an alternative embodiment the addresses, via which the memory module is accessed, are files in a file system of the storage device. In this embodiment the address allocated to the access indirectly indicates, namely via a file system, where the memory is to be accessed. This can be of advantage e.g. when the operating system of the terminal device is not adapted to directly output block memory addresses, as is the case e.g. in JAVA applications.

When the addresses are files of a file system, it can be provided in a special embodiment that at least one file in the file system has permanently allocated thereto a defined block address. In this way a block address of the memory is indirectly allocated via a file of the file system and vice versa.

The invention also comprises a method for accessing a data storage device having an additional module and at least one memory module with the steps: sending a command to the data storage device with an address on which the command is to be executed; providing a predefined additional functional address, the additional functional address being an address for the command to be executed on the memory module; determining whether the address of the command corresponds to the predefined additional functional address; optionally: converting or changing the command and forwarding it to the additional module, if the address of the command is defined as an additional functional address; forwarding the command to the memory module, if the address of the access command is not defined as an additional functional address.

Further features and advantages of the invention appear from the following description of preferred embodiments, only by way of example and not restricted to it, with reference to the accompanying Figures.

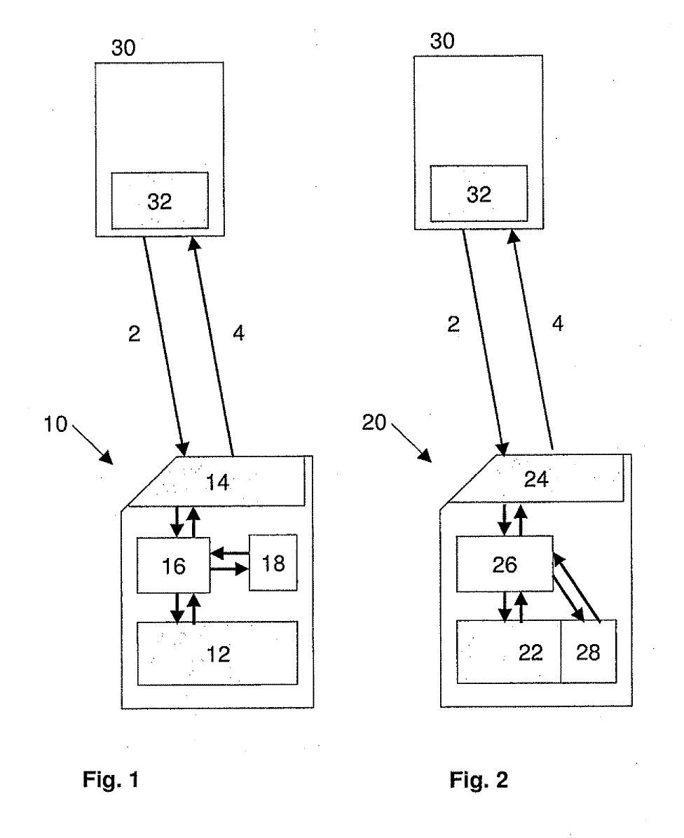

FIG. 1 shows a first embodiment of a memory card according to the invention having additional functionality;

FIG. 2 shows a second embodiment of a memory card according to the invention having additional functionality; and

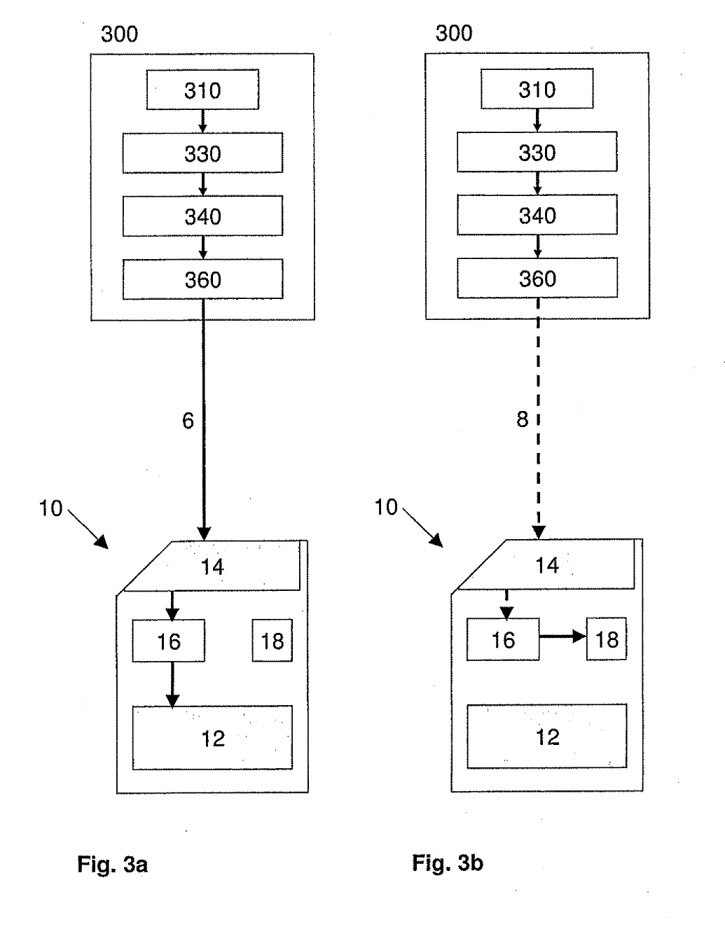

FIGS. 3a and 3b show the access to a memory card having additional functionality.

In the Figures and the following description of special embodiments the same or similar parts are referred to with the same reference signs.

FIG. 1 shows a first embodiment of a memory card according to the invention 10, for example a multimedia card (MMC) or an SD card, having additional functionality. Memory card 10 comprises an interface with contacts 14, via which card 10 by means of signals 2 and 4 communicates with an electronic terminal device 30. Interface 14 corresponds to the memory card 10 used and is, for instance, an MMC or an SD interface. Besides, interface 14 can also have the form of a usual smart card interface, for instance a PC/SC interface. Terminal device 30 here serves as a hardware platform and can be a PC, PDA, smart phone, a digital camera, an audio device (MP3 player) or the like which is provided with a card reader 32.

Memory card 10 has a controller 16, a memory module 12 and an additional module 18, wherein controller 16 communicates with memory module 12 to write data in the memory module or to read out such data from such memory module. The memory can be a flash memory. Controller 16 also communicates with additional module I 8, which in a preferred embodiment is a smart card chip. Thus, on the basis of the signal 2 transmitted by the terminal device 30 controller 16 can decide, whether it forwards a signal to the memory module 12 and/or to the additional module 18 and then activates functions of the memory module 12 and/or the additional module 18, or whether it processes the signal. Controller 16 thus has the function of a decoder or switch, which depending on the signal 2 received and/or on command 8 actuates different modules, e.g. additional module 18 or “normal” memory 12, or the same module with different instructions.

FIG. 2 shows an alternative embodiment of a memory card according to the invention 20, which, too, communicates via an interface 24 having contacts by means of signals 2 and 4 with the electronic terminal device 30. Card reader 32 and terminal device 30 can be designed identically with the device described in FIG. 1 and in particular communicate via the same interface configuration, for example an MMC, SD, or PC/SC interface.

Memory card 20 is provided with a controller 26 and a memory module 22, a portion of the memory module being reserved for the additional module 28. In this embodiment it is not necessary to integrate a separate component, such as a smart card chip, in the memory card, the memory element is configured such that a certain portion, for example certain memory blocks, are reserved for the additional functionality and thus as an additional module.

FIGS. 3a and 3b show the functional principle of an access to memory card 10 of FIG. 1; such principle, however, can also be analogously applied to other storage devices according to the invention.

Terminal device 300 is operated by an operating system 330, for example PocketPC, Symbian, Linux or a Windows operating system. An application 310 sends a command, for example a read or write command, to operating system 330 to read out or to write in a certain file and/or a certain block of the memory which is identified in the access command by means of an address. Operating system 330 converts the command and forwards it together with the address to driver 340 for the memory card. Driver 340, for example a standard flash card driver, forwards the command together with the address to a host controller 360, which forwards such command via the interface and contacts 14 to the controller 16 of the memory card 10.

In an upstream configuration phase the additional functional address has been reserved or defined. Such configuration is communicated to the operating system and the application.

Controller 16 determines whether the address corresponds to a predetermined additional functional address. If the address of a command 6 does not correspond to the additional functional address, controller 16 will transmit the command to memory module 12 or execute the command on memory module 12, as shown in FIG. 3a.

If the address of a command 8 corresponds to the additional functional address, controller 16 will forward command 8 to additional module 18, as shown in FIG. 3b.

Then command 8 can be processed in additional module 18. For this purpose additional module 18 can be provided with an additional module controller.

Controller 16 can also be configured to process command 8 and to activate a function of the additional module 18 or to execute another instruction, when the address of the command 8 corresponds to the additional functional address.

In a preferred embodiment controller 16, 26 comprises a switch unit which is destined to convert command 8 for accessing the card into instructions to additional module 18, 28, when command 8 was addressed to the additional functional address.

1. A data storage device having an additional module, comprising:
at least one memory module which is accessible via addresses;
at least one controller controlling an access to the memory module,
wherein at least one of the addresses is defined as an additional functional address and wherein the controller is configured to forward an access to the memory module, which is effected via the additional functional address, to the additional module.

2. The data storage device according to claim 1, wherein the access to the memory module is effected via commands, the commands applying to all addresses.

3. The data storage device according to claim 1, wherein the controller comprises an evaluation unit, which is configured to evaluate accesses addressed to the memory module and to activate the additional module when accesses are effected via the additional functional address.

4. The data storage device according to claim 1, wherein the controller comprises a switch unit, which is configured to process the access to the memory module and to convert the access into instructions to the additional module.

5. The data storage device according to claim 1, wherein the additional module comprises an additional controller.

6. The data storage device according to claim 1, wherein the additional module is a security module and wherein an access via the additional functional address activates a security functionality of the security module.

7. The data storage device according to claim 1, wherein the additional module comprises a smart card chip.

8. The data storage device according to claim 1, wherein the additional module comprises a reserved memory area of the memory module.

9. The data storage device according to claim 1, wherein the addresses, via which the memory module is accessed, are block addresses of the memory module.

10. The data storage device according to claim 1, including a file system, and wherein the addresses, via which the memory module is accessed, are files in the file system.

11. The data storage device according to claim 10, wherein the files in the file system have defined block addresses permanently allocated thereto.

12. The data storage device according to claim 1, wherein the memory module is a nonvolatile flash memory.

13. A controller for controlling an access to a memory module which can be accessed via addresses, wherein at least one of the addresses is reserved as an additional functional address; the controller comprising an arrangement for accessing an additional module if said access to the memory module is effected via the additional functional address.

14. A system comprising:
a data storage device according to claim 1; and
a terminal having an operating system and at least one standard driver for operating the data storage device,
wherein the terminal is configured to access the data storage device via a standard interface.

15. The system according to claim 14, wherein the standard interface is provided in a receiving means for the data storage device.

16. The system according to claim 15, wherein the receiving means is a writing and/or reading device for SD memory cards, multimedia cards, compact flash cards and/or for USB memory sticks.

17. The system according to claim 15, wherein the standard interface is an MMC, SD or PC/SC interface.

18. A method for accessing a data storage device having an additional module and at least one memory module, comprising the steps:
sending a command to the data storage device with an address for accessing the memory module;
providing a predefined additional functional address, wherein the additional functional address corresponds to an address for accessing the additional module;
determining whether the address of the command is defined as an additional functional address;
forwarding the command to the additional module if the address of the command is defined as an additional functional address.

19. A method for accessing a data storage device according to claim 18, wherein forwarding the command comprises processing and/or converting the command into instructions to the additional module.

20. The method for accessing a data storage device according to claim 18, wherein the commands apply to all addresses.

21. The method for accessing a data storage device according to claim 18, wherein said determining and/or forwarding is carried out by a controller.

22. The method for accessing a data storage device according to claim 18, wherein the addresses, via which the memory module is accessed, are block addresses of the memory module.

23. The method for accessing a data storage device according to claim 18, wherein the addresses, via which the memory module is accessed, are files in a file system of the storage device.

24. The method for accessing a data storage device according to claim 23, wherein the files in the file system are allocated to permanent block addresses.

25. A computer program product for accessing a data storage device having an additional module, which can be directly loaded into a memory of a computer or microcomputer, comprising software code portions with which the method steps according to claim 18 are carried out, when the computer program product is executed on a processor of the computer or microcomputer.
